(19) United States
(12) Patent Application Publication
(10) Pub. No.: US 2024/0101439 A1
(43) Pub. Date: Mar. 28, 2024

(54) METHOD FOR MANUFACTURING OBJECTS COMPRISING BERYLLIUM

(71) Applicant: Materion Corporation, Mayfield Heights, OH (US)

(72) Inventor: Andrew Ruzek, Mayfield Heights, OH (US)

(73) Assignee: Materion Corporation, Mayfield Heights, OH (US)

(21) Appl. No.: 18/472,552

(22) Filed: Sep. 22, 2023

Related U.S. Application Data
(60) Provisional application No. 63/409,102, filed on Sep. 22, 2022.

(51) Int. Cl. C01F 3/00; C01F 1/00

(52) U.S. Cl. CPC C01F 3/00; C01F 1/00; C01P 2002/08; C01P 2002/20; C01P 2004/61

(57) ABSTRACT

Methods for manufacturing an object comprising beryllium by depositing layers of beryllium and metal inoculants are disclosed. Grain refinement allows the beryllium article to have beneficial properties in terms of strength and durability.

### CROSS REFERENCE TO RELATED APPLICATIONS

This application claims priority to U.S. Provisional Application No. 63/409,102, filed Sep. 22, 2022, which is fully incorporated by reference herein.

### TECHNICAL FIELD

The present disclosure relates to a method for producing objects comprising beryllium. In particular the method involves depositing successive layers that are solidified to form a continuous beryllium matrix having a crystalline structure of equiaxed grains.

### BACKGROUND

Beryllium is a metal with highly desirable properties. These include high stiffness (Young's modulus=287 GPa), low density (1.85 g/cc), high elastic modulus (130 GPa), high specific heat (1925 J/kg·K), high thermal conductivity (216 W/m·K), and a low coefficient of linear thermal expansion (11.4×10⁶/° K). As a result, beryllium and its composites are useful in airborne and spaceborne structures, high-performance engines and brakes, and electronic components for thermal performance and vibration damping. Beryllium and its composites are also useful in several different applications, including combustion applications, hypersonic vehicles, computer parts, optics for space- and ground-based systems, satellite structures, solar energy collectors, and nuclear energy growth applications.

One limitation is that casting methods are unsuitable for manufacturing a beryllium product, and lead to columnar solidification. Beryllium is a highly reactive metal with a high melting point, making it susceptible to reaction with mold-wall materials to form beryllium compounds (BeO, etc.) that become entrapped in the solidified metal. In addition, the grain size is greater than 500 microns and typically much higher, up to 50,000 microns. This is far too large to meet strength requirements and results in a brittle material. Further attempts to refine grains through mechanical working have not met with commercial success. To overcome the beryllium production problem, beryllium powder has been used. Beryllium powder can be formed by ball milling, disk grinding, or gas atomizing process. The powder is consolidated into ingots that can be further processed into shaped components of beryllium. This process requires careful handling of the beryllium powder. In addition, the powder process has low material utilization that leads to inefficiencies and increased costs. The powder process is also limited in its ability to form complex shapes.

Objects built by depositing layers may allow for complex shapes but still suffer from poor crystalline structures due to a lack of plastic deformation from mechanical forming. As the layers are built in one direction, the solidification tends to result in poor microstructure and columnar grains are prevalent. Undesirable reductions in mechanical properties result in a loss of strength and durability.

There still remains a need to eliminate columnar solidification for producing beryllium articles having reduced grain size in an efficient manner.

### SUMMARY

The present disclosure relates to methods for making beryllium articles by reducing or, more preferably, eliminating columnar structure. The microstructure of the beryllium article is improved by adding inoculants, thereby improving mechanical properties. In one embodiment, the methods disclosed herein provide for forming molten beryllium intro a layer comprising a continuous beryllium matrix having a crystalline structure of equiaxed grains. An increase in equiaxed grains is preferred to obtain more consistent microstructures. Grain refinement achieved by the disclosed embodiments also allow for the production of complex objects made from beryllium having an average grain size from 1 to 80 microns, preferably average grain size from 5 to 40 microns.

In one aspect there is provided a method of manufacturing an object comprising beryllium, the method comprising preparing a mixture of beryllium powder and at least one metal inoculant; depositing a layer comprising the mixture on a surface; applying energy to at least a portion of the layer to form molten beryllium in a reducing atmosphere; solidifying the molten beryllium into a layer comprising a continuous beryllium matrix having a crystalline structure of equiaxed grains; and repeating the depositing/applying/solidifying for successive layers until the object having a geometric shape is achieved. In one embodiment, at least a portion of the metal inoculants are bound to the surface of the beryllium powder. The metal inoculants may include at least one particle comprising Be₂Co, Be₂Nb, Be₂Ta, Be₂Ti, Be₂W, Be₅Elf, Be₅Sc, Be₅Zr, Be₇Cu₁₃, BeFe₃, Cu₃Mo, Cu₉W, Mo, Nb, RbO₂, ReRh, Ta, TiV, or W. Preferred metal inoculants may include Be₂Co, Be₂Nb, Be₂Ta, Be₂Ti, Be₂W, Be₅Elf, Be₅Sc, or Be₅Zr. The mixture, which may be prepared by blending, atomization, mechanical alloying, or resonant mixing, comprises from 90 to 99.99% by weight of beryllium and from 0.01 to 10% by weight of the at least one metal inoculant. The beryllium powder may have a D50 average size from 10 to 50 microns. The metal inoculant may have a D50 average size from 0.001 to 5 microns. In one embodiment, an electron beam or laser is used to apply energy to at least a portion of the layer.

In one aspect there is provided a method of grain refining an object comprising beryllium, the method comprising combining beryllium and at least one metal inoculant selected from the group consisting of Be₂Co, Be₂Nb, Be₂Ta, Be₂Ti, Be₂W, Be₅Elf, Be₅Sc, Be₅Zr, Be₇Cu₁₃, BeFe₃, Cu₃Mo, Cu₉W, Mo, Nb, RbO₂, ReRh, Ta, TiV, and W to form a pre-alloy composition; depositing a layer comprising the pre-alloy composition on a surface; cycling at least a portion of the layer by applying energy to form molten beryllium; solidifying the molten beryllium; and repeating the depositing/cycling/precipitating for successive layers, wherein each of the successive layers comprise the pre-alloy composition and have an average grain size from 1 to 80 microns. Preferred metal inoculants may include Be₂Co, Be₂Nb, Be₂Ta, Be₂Ti, Be₂W, Be₅Elf, Be₅Sc, or Be₅Zr. The pre-alloy composition comprises from 90 to 99.99% by weight of beryllium and from 0.01 to 10% by weight of the at least one metal inoculant.

In another aspect there is provided an object comprising beryllium, wherein the beryllium is in a crystalline structure comprising equiaxed grains of beryllium; and at least one metal inoculant selected from the group consisting of Be₂Co, Be₂Nb, Be₂Ta, Be₂Ti, Be₂W, Be₅Elf, Be₅Sc, Be₅Zr, Be₇Cu₁₃, BeFe₃, Cu₃Mo, Cu₉W, Mo, Nb, RbO₂, ReRh, Ta, TiV, and W to form a grains that are 1:1 or 2:1 lattice match to the beryllium grains; wherein the equiaxed grains of beryllium has an average grain size from 1 to 80 microns. The crystalline structure may comprise from 50 vol. % to 100 vol. % of equiaxed grains. Preferred metal inoculants may include Be₂Co, Be₂Nb, Be₂Ta, Be₂Ti, Be₂W, Be₅Elf, Be₅Sc, or Be₅Zr.

These and other non-limiting characteristics are more particularly described below.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The singular forms “a”, “an”, and “the” include plural referents unless the context clearly dictates otherwise.

As used in the specification and in the claims, the term “comprising” may include the embodiments “consisting of” and “consisting essentially of” The terms “comprise(s)”, “include(s)”, “having”, “has”, “can”, “contain(s)”, and variants thereof, as used herein, are intended to be open-ended transitional phrases that require the presence of the named ingredients/steps and permit the presence of other ingredients/steps. However, such description should be construed as also describing compositions or methods as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application, as they relate to mixtures, pre-alloy compositions or objects, reflect average values for a composition that may contain individual polymers of different characteristics. The numerical values disclosed herein should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 1 micron to 80 microns” is inclusive of the endpoints, 1 micron and 80 microns, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially”, may not be limited to the precise value specified, in some cases. The modifier “about” should also be considered as disclosing the range defined by the absolute values of the two endpoints. For example, the expression “from about 2 to about 4” also discloses the range “from 2 to 4”. The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As described herein, there is a method for producing a beryllium article. Beryllium powder and a metal inoculant are used to form a continuous beryllium matrix having a crystalline structure of equiaxed grains. To start, a mixture of beryllium, preferably beryllium powder, and a metal inoculant is prepared. In some embodiments, the mixture may be referred to as a pre-alloy composition. The mixture may evenly distribute the metal inoculants in the beryllium powder. The mixture of beryllium powder and metal inoculant is exposed to an energy source and solidified by cycling through heating and cooling to produce a continuous beryllium matrix having a crystalline structure of equiaxed grains. It has been found that the added metal inoculants act as nucleating sites for forming fine grain structures during the solidification. The steps may be repeated until the object having a geometric or three-dimensional shape is obtained. In one embodiment, the mixture of beryllium, preferably beryllium powder, and a metal inoculant may be cycled through heating and cooling to allow each layer to have a continuous beryllium matrix having a crystalline structure of equiaxed grains. In one embodiment, the grain structure of the beryllium article may have equiaxed grains after the heating/cooling cycle(s).

Without being bound by theory, the presence of equiaxed grains is shown to contribute to the grain refinement of the beryllium article. The grain refinement of beryllium articles can lead to improved strength and processing when forming an article with a series of layers. In one embodiment, the beryllium article may have an average grain size from 1 to 80 microns, e.g., from 1 to 75 microns, from 1 to 60 microns, from 1 to 50 microns, from 1 to 40 microns, from 5 to 40 microns, from 5 to 25 microns, from 5 to 15 microns, or from 10 to 15 microns. In one embodiment, a portion of the grains of the beryllium article may have an aspect ratio of less than 3:1. In particular, 75% of the grains of the beryllium article may have an aspect ratio of less than 3:1, e.g., less than 2.5:1 or less than 2:1. Average grain size and aspect ratio may be determined using optical imaging, such as SEM imaging, and by using the comparison, planimetric, or intercept parameters of ASTM E 112-12.

The resulting grain structure of the object comprising beryllium has a significantly reduced average grain size compared to a process that does not include the disclosed metal inoculants.

The beryllium matrix comprises crystals of beryllium that form grains, each grain with its own distinct orientation. Grains are connected together via grain boundaries that are formed during the cyclic process of applying energy and solidification. Grain boundaries can influence the mechanical properties. The crystalline structure comprises equiaxed grains due to the metal inoculants that form many sites for grain refinement. In one embodiment, the object comprising beryllium has a continuous beryllium matrix having a crystalline structure of equiaxed grains. Equiaxed grains are roughly similar in length, width and height. In one embodiment, the crystalline structure comprises 50 vol. % or more of equiaxed grains, e.g., 75 vol. % or more of equiaxed grains, or 90 vol. % or more of equiaxed grains. In terms of ranges, the crystalline structure may comprise from 50 vol. % to 100 vol. % of equiaxed grains, e.g., from 75 vol.% to 100 vol. % or from 90 vol. % to 100 vol. %. Increasing the amount of equiaxed grains decreases the amount of columnar grains. The quantification of the grains may be done using microscopy techniques, such as x-ray diffraction analysis.

In one embodiment, the metal inoculant or inoculants that are combined with beryllium include metals that form 1:1 or 2:1 interfaces with the edges of the beryllium grains. In one embodiment, at least a portion of the metal inoculants are bound to the surface of the beryllium powder. This can allow distribution of the metal inoculants throughout the beryllium matrix. The metal inoculant may be present as a loose powder, a paste, or a suspension that may be combined with beryllium. In one embodiment, the metal inoculant remains unreacted when bound to the surface of the beryllium powder. There are several ways to combine the metal inoculants and beryllium, such as mixing, blending, atomization, mechanical alloying, resonant mixing, or combinations thereof. Resonant mixing is useful when the beryllium powder and metal inoculant have a different size to achieve a thorough mix. In one embodiment, resonant mixing induces non-contact acoustic mixing with acoustic waves in the frequency from 20 to 80 Hz to achieve good mixing in a short time without inducing fractures or stress to the beryllium and metal inoculants. Accordingly, one metal inoculant may be combined with the beryllium, while in some embodiments, there may be a mixture of metal inoculants.

In one embodiment, the metal inoculant may comprise Be₂Co, Be₂Nb, Be₂Ta, Be₂Ti, Be₂W, Be₅Elf, Be₅Sc, Be₅Zr, Be₇Cu₁₃, BeFe₃, Cu₃Mo, Cu₉W, Mo, Nb, RbO₂, ReRh, Ta, TiV, or W. Combinations of metal inoculants may be used in some embodiments. More preferably, the metal inoculant may comprise Be₂Co, Be₂Nb, Be₂Ta, Be₂Ti, Be₂W, Be₅Elf, Be₅Sc, or Be₅Zr. In particular, the metal inoculants introduce grain refinement and provide for a crystalline structure of equiaxed grains. These metal inoculants may be efficiently matched to the beryllium in terms of interatomic spacing misfit and interplanar spacing misfit. The crystal orientation may be measured by polarized optical microscopy and/or EBSD (Electron Backscatter Diffraction).

In one embodiment, the mixture preparation step may be optional, and beryllium and metal inoculant may be deposited as a layer without forming a mixture. Accordingly, there is provided a method of producing a beryllium article comprising depositing a layer comprising beryllium and metal inoculant on a surface, heating at least a portion of the layer by applying energy to form molten beryllium, solidifying the molten beryllium, and repeating the depositing/cycling/precipitating for successive layers. After the desired layers are built up, the object may be formed wherein the beryllium-based article has an average grain size from 1 to 80 microns.

In one embodiment, the metal inoculant may be a metal powder. The metal powder may have an aspect ratio (mean length to mean width) from 1:1 to 100:1, e.g., from 1:1 to 50:1, from 1:1 to 20:1, from 1:1 to 10:1 or from 1:1 to 5:1. The metal powder may be smaller than the beryllium powder. The metal powder may have an average (D₅₀) particle size of less than 10 microns, e.g., less than 8 microns, less than 5 microns, less than 2.5 microns, less than 2 microns or less than 1 micron. In some embodiments, the metal powder may be a nanoparticle; e.g., may have an average (D₅₀) less than 1 micron. In some embodiments, the nanoparticles may have an average (D₅₀) that is from 10 to 1000 nanometers, e.g., 25 to 950 nanometers, 50 to 900 nanometers, 100 to 800 nanometers, or from 300 to 700 nanometers. Accordingly, the metal powder may have an average (D₅₀) particle size from 0.0001 to 10 microns, e.g., from 0.0005 to 7.5 microns, from 0.001 to 5 microns, from 0.01 to 2.5 microns, or from 0.1 to 1.5 microns. The particle size is the D₅₀, or the diameter at which a cumulative percentage of 50% of the particles by volume is attained.

In one embodiment, each deposited layer may comprise beryllium in an amount from 90 to 99.99% by weight, based on the total weight of each layer. More preferably, each layer may comprise beryllium in an amount from 95 to 99.9% by weight, e.g. from 97 to 99.5% by weight or from 98 to 99% by weight.

In one embodiment, the beryllium includes beryllium powder. Exemplary beryllium powders include S-65 grade (99.2% minimum Be content, 0.9% max BeO), S-200 (98.5% minimum Be content), 0-30 (Hot Isostatically Pressed beryllium, minimum 99% Be content, 0.5% max BeO), and, all available from Materion Corporation. The beryllium powder may have an aspect ratio (mean length to mean width) from 1:1 to 100:1, e.g., from 1:1 to 50:1, from 1:1 to 20:1, from 1:1 to 10:1 or from 1:1 to 5:1. In one embodiment, the beryllium powder may be a spherical shape. The beryllium powder may have an average (D₅₀) particle size of from 1 micron to 200 microns, e.g., from 5 microns to 175 microns, from 10 microns to 150 microns, from 15 microns to 100 microns, from 25 microns to 70 microns or from 25 microns to 50 microns. The particle size is the D₅₀, or the diameter at which a cumulative percentage of 50% of the particles by volume is attained. Powders that are smaller than 200 microns may be constructively used to form beryllium articles with reduced grain refinement. When needed, the beryllium powder may be sieved to achieved a desired size.

In one embodiment, the beryllium powder may be in the form of particles having a core-shell structure, with the beryllium making up the core and a continuous or a semi-continuous coating making up the shell. In some embodiments, the continuous or a semi-continuous coating may be include a metal inoculant. Coating the beryllium may be achieved by ball milling, resonance mixing, spray binding, spray drying, laser ablation, electrical-discharge machining, and atomic layer deposition. In some embodiments, the coating includes nickel, either pure nickel or in the form of a nickel alloy. The core may be from 0.1 wt % to 99.9 wt % of the particles, or from 50 wt % to 99.9 wt %, or from about 92 wt % to less than 100 wt % of the particles. In some embodiments, the coating may be from 0.1 wt % to 99.9 wt % of the particles, or from 0.1 wt % to 50 wt %, or from greater than zero wt % to about 8 wt % nickel. In particular embodiments, the beryllium powder includes from about 92 wt % to less than 100 wt % beryllium and from greater than zero wt % to about 8 wt % nickel. Generally, it is contemplated that the coating forms the particles for grain refinement.

The metal inoculant may be combined with beryllium in effective amounts to increase the number of grains during solidification. In one embodiment, the metal inoculant may be present in an amount of 0.01 to 10% by weight, based on the total weight of each layer. More preferably, the metal inoculants may be present in an amount from 0.1 to 5% by weight, e.g., 0.5 to 3% by weight, or from 1 to 2% by weight.

By cycling several deposited layers, an object comprising beryllium article may be formed. In particular, the method may achieve a three-dimensional beryllium article. In the method, the cycling may involve applying energy to at least a portion of the layer to form molten beryllium and solidifying the molten beryllium into a layer through cooling. After cycling above a temperature to form molten beryllium, the molten beryllium is solidified. The formation of crystalline structure of equiaxed grains is provided to achieve the desired grain refinement. The crystalline structure of equiaxed grains may also reduce or eliminate columnar grain growth. In one embodiment, complex shapes may be formed from the articles having multiple layers. In one embodiment, the resulting shape may be geometric shape or a three-dimensional shape that is formed from multiple layers. In one embodiment, the method deposits an initial layer, preferably at a relatively high rate. In one embodiment, the initial layer may be uniformly deposited by depositing the mixture on a surface of a substrate. In some embodiments, the initial layer may be deposited on a surface such as a substrate, platform, or base plate.

The method may begin by depositing the initial layer in a build box. Preferably the mixture comprising beryllium powder and the metal inoculant is transferred to the build box with minimal loss or contamination of the surrounding area. The build box comprises a surface, e.g., build platform, and side walls. The build platform is generally a flat surface on which the successive layers are deposited. The build platform may move along a vertical z-axis based on signals provided from a computer-operated controller. The side walls cooperate with the build platform to form a “box” that contains the deposited mixture. Generally, the side walls remain in a fixed location, and the build platform moves downward to permit the next layer of mixture to be deposited.

Each layer may be deposited in a pre-determined pattern on the surface. In some embodiments, the preset pattern is determined based on the layers of a computer-aided design (CAD) model. Any suitable technique to deposit the initial layer is suitable for the method including spreading, coating, brushing, rolling, spraying, or dispensing. In one embodiment, one or more deposition heads are used and are moved in horizontal x-y plane. A controller may be used to move the one or more deposition heads as specified by the design. The horizontal x-y plane is a plane defined by an x-axis and a y-axis where the x-axis, the y-axis, and the z-axis are orthogonal to each other.

In some embodiments, the deposition occurs under an inert gas atmosphere. In one embodiment, the deposition may occur in a reducing atmosphere to reduce the formation of oxides. After the layer of beryllium and the metal inoculants are deposited, energy may be applied in a reducing atmosphere. In one embodiment, the reducing atmosphere contains less than 20 vol % of oxygen or other oxidizing agents, e.g., less than 15 vol. %, less than 10 vol. % or less than 5 vol. %.

In one embodiment, each layer may be deposited in an even manner. The initial layer may have a thickness from 20 to 200 microns, e.g., from 25 to 150 microns, from 25 to 110 microns, from 30 to 100 microns, from 35 to 75 microns, or from 40 to 60 microns. In some embodiments, the layer may be formed by compacting the deposited materials in an optional compaction method. Compacting powders may be desired to provide thin layers using a mechanical compactor such as doctor blades or double rolling or electrostatic force. In some embodiments, the layers may be deposited.

Subsequent to the deposition of the initial layer, the method uses a cycling process to apply energy, preferably from an electron beam or laser, to at least a portion of the layer to form molten beryllium followed by solidifying the molten beryllium into a layer. In one embodiment, the method involves solidifying the molten beryllium into a layer comprising a continuous beryllium matrix having a crystalline structure of equiaxed grains. The cycling transitions through a thermal gradient at a high rate to form molten beryllium. In one embodiment, the energy source may be directed to at least a portion of the initial layer. The energy source may produce localized or focused energy to heat at least a portion of the initial layer, preferably to heat at least a portion of the initial layer. In one embodiment, the energy source may be sufficient to form molten beryllium. The energy source may be an electron beam or laser beam having a power density from 10³ W/mm² to 10⁷ W/mm², e.g., from 10⁴ W/mm² to 10⁷ W/mm², or from 10⁵ W/mm² to 10⁶ W/mm². Operating the energy source at a power of less than 10⁷ W/mm² is sufficient to form molten beryllium. In one embodiment, the effective diameter of the energy source may be from 10 to 200 microns, e.g., from 25 to 150 microns, or from 35 to 100 microns. The scanning speed of the energy source may be 10 mm/s to 2000 mm/s, e.g., from 50 to 1500 mm/s or from 100 to 1000 mm/s. The raster width of the energy source may be from 50 to 500 microns, e.g., from 75 to 450 microns, from 75 to 400 microns, or from 100 to 350 microns. In one embodiment, the layer thickness may be from 20 microns to 200 microns, e.g., from 25 microns to 175 microns or from 50 microns to 150 microns.

In one embodiment, the energy source and/or another source heats the initial layer to a temperature from 1000° C. to 1600° C., e.g. from 1100° C. to 1450° C., from 1200° C. to 1400° C., or from 1290° C. to 1325° C. In one embodiment, the applied energy is applied for a duration of less than 300 seconds, e.g., less than 240 seconds, less than 180 seconds, less than 120 seconds, less than 90 seconds, less than 60 seconds, less than 50 seconds, less than 45 seconds, less than 30 seconds, less than 25 second, less than 20 seconds, less than 10 second, less than 5 second, less than 1 second, or less than 0.5 second. In terms of ranges, in one embodiment, the energy is applied for a period from 0.01 to 300 seconds, e.g., from 0.01 to 240 seconds, from 0.1 to 180 seconds, from 0.2 to 120 seconds, from 0.2 to 90 seconds, from 0.25 to 60 seconds, from 0.5 to 60 seconds, from 0.5 to 30 seconds, from 0.5 to 15 seconds, or from 0.5 to 10 seconds.

Unless pre-heating is used, the initial layer may be deposited at room temperature (20 to 25° C.). In some embodiments, the deposited initial layer may be pre-heated in the build box to a temperature of at least 100° C., e.g., at least 120° C., or 150° C., at least 200° C., at least 400° C., at least 450° C., or at least 500° C.

The thermal conditions of the article may be monitored using infrared temperature sensors, thermocouples, resistance temperature detectors, thermistors, or other suitable temperature sensors. The sensors may monitor the temperature in the region where the energy and/or coolant is applied. In response to the temperature, the method may adjust the cooling rate by adjusting the flow rate, duration or temperature of the coolant.

Operating the method under a reduced atmospheric pressure or under vacuum may provide quality control for the layers and beryllium article material. Nonetheless, in some embodiments, the method may be operated under atmospheric pressure.

As part of the cycling process, the method also cools the deposited layer. In one embodiment, minimum cooling rates may be greater than 10° C./min, e.g., greater than 15° C./min or greater than 20° C./min. In some embodiments, the cooling rates may be greater than 1000° C./min, e.g., greater than 10,000° C./min, to achieve solidification. The cooling or undercooling may be achieved at a cooling rate from 10° C./min to 10,000° C./min, e.g., from 20° C./min to 5,000° C./min, from 50° C./min to 3,000° C./min or from 100° C./min to 1000° C./min. In one embodiment, the cooling may be in the building direction of the layers. During the solidification, the molten beryllium forms into a continuous beryllium matrix having a crystalline structure of equiaxed grains. In one embodiment, the crystalline structure is not solely oriented in the build direction.

In one embodiment, the cooling or undercooling for solidification may be reduced due to the lattice matching of the metal inoculants and continuous beryllium matrix and low interfacial energy. Stress reduction may be improved during the solidification of each layer to produce the object comprising beryllium.

A coolant may be used to achieved the desired cooling. The coolant may further reduce temperature gradients in the layers that tend to provide for the formation of columnar grains and thus improves the grain refinement. In one embodiment, the coolant may be an inert gas such nitrogen or a noble gas, in particular argon. The coolant may be a mixture of gases. The coolant may be delivered to the layer as a focused gaseous stream at a temperature of less than or equal to 100° C., e.g., less than or equal to 75° C., less than or equal to 50° C., less than or equal to 25° C., less than or equal to 0° C., less than or equal to −10° C., less than or equal to −25° C. or less than or equal to −50° C. In terms of ranges the coolant may be applied at a temperature from −200° C. to 100° C., e.g., from −150° C. to 50° C. or from −100° C. to 25° C., including subranges therein. The flow of the coolant may be adjusted as the layers are deposited and the flow rate may be less than 500 L/min, e.g., less than 250 L/min or less than 100 L/min.

The method may continue for successive layers in a similar manner, thus cycling each layer of deposited mixture and forming a layer of continuous beryllium matrix having a crystalline structure of equiaxed grains. After allowing a sufficient time for precipitation, one or more successive layers may be deposited in a pre-determined pattern on at least a portion of the initial layer opposite of the surface. This continues to build the beryllium article where each of the successive layers are deposited on at least a portion of the previously deposited layer. In one embodiment, the successive layers are deposited to achieve a complex shape, such as a three-dimensional shape. The successive layers may be deposited at room temperature or may be pre-heated similarly to the initial layer. In a similar manner, an energy source is directed to at least a portion of the successive layer for cycling above a temperature that forms molten beryllium. In one embodiment, the energy source is controlled within similar operating parameters as the initial layer. Depending on the article, the pattern for each successive layer may be different. In some embodiments, the successive layer(s) may be deposited on at least a portion of the prior or initial layers.

In some embodiments, the surface or build plate may be lowered by the thickness of the next successive layer. The thickness of the successive layers may vary and in one embodiment, the successive layer may have a thickness from 20 to 200 microns, e.g., from 25 to 150 microns, from 25 to 110 microns, from 30 to 100 microns, from 35 to 75 microns, or from 40 to 60 microns. In some embodiments, each successive layer may have a similar thickness or the thickness may accommodate the beryllium article. The method may continue with repeated deposition, cycling and precipitation until the desired beryllium article is formed. In one embodiment a three-dimensional object is formed. In one embodiment, the beryllium article may be formed by one or more successive layers, e.g., at least 5 successive layers, at least 10 successive layers, or at least 20 successive layers. For some articles, several hundred layers may be used and thus the number of layers are not limited.

Each of the successive layers may comprise metal inoculants and the method may repeat the depositing/applying/solidifying steps for each layer.

The orientation of the microstructure is not limited to the build direction of the successive layers. The microstructure of the object comprising beryllium may contain a plurality of dendrite layers having differing primary growth-direction angles with respect to each other. This provides for an object comprising beryllium that is crack-free, with complex shapes that can be produced in an efficient manner in terms of cost, material, and time. The presence of the metal inoculants further improves the crack-free nature of the object.

In some embodiments, the methods further include curing the plurality of layers prior to sintering the preform. In one embodiment, the beryllium article may be solutionized followed by a quench. The beryllium article may be annealed for a period from 6 to 12 hours, e.g., from 8 to 10 hours. The quenching rate may be greater than 25° C./min, e.g., greater than 50° C./min or greater than 100° C./min. The quenching may be done slowly at room temperature. The annealed article can be finished, for example by polishing or plating. The surface roughness of the article may be reduced, for example, via bead blasting or barrel finishing. In some embodiments, the manufactured beryllium article may have loose or unfused particles in one or more of the layers. The unfused particles may be removed by blowing or vacuuming as needed.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

As used below, any reference to a series of embodiments is to be understood as a reference to each of those embodiments disjunctively (e.g., “Embodiments 1-4” is to be understood as “Embodiments 1, 2, 3, or 4”).
Embodiment 1 is a method of manufacturing an object comprising beryllium, the method comprising preparing a mixture of beryllium powder and at least one metal inoculant; depositing a layer comprising the mixture on a surface; applying energy to at least a portion of the layer to form molten beryllium in a reducing atmosphere; solidifying the molten beryllium into a layer comprising a continuous beryllium matrix having a crystalline structure of equiaxed grains; and repeating the depositing/applying/solidifying for successive layers until the object having a geometric shape is achieved.
Embodiment 2 is an embodiment of embodiment 1, wherein at least a portion of the metal inoculants are bound to the surface of the beryllium powder.
Embodiment 3 is an embodiment of any one of embodiments 1 or 2, wherein the at least one metal inoculant comprises at least one particle selected from the group consisting of Be₂Co, Be₂Nb, Be₂Ta, Be₂Ti, Be₂W, Be₅Hf, Be₅Sc, Be₅Zr, Be₇Cu₁₃, BeFe₃, Cu₃Mo, Cu₉W, Mo, Nb, RbO₂, ReRh, Ta, TiV, and W.
Embodiment 4 is an embodiment of any one of embodiments 1 or 2, the at least one metal inoculant comprises at least one particle selected from the group consisting of Be₂Co, Be₂Nb, Be₂Ta, Be₂Ti, Be₂W, Be₅Hf, Be₅Sc, and Be₅Zr.
Embodiment 5 is an embodiment of any one of embodiments 1-4, the continuous beryllium matrix has an average grain size from 1 to 80 microns.
Embodiment 6 is an embodiment of any one of embodiments 1-5, wherein the continuous beryllium matrix has an average grain size from 5 to 40 microns.
Embodiment 7 is an embodiment of any one of embodiments 1-6, wherein the continuous beryllium matrix has an average grain size from 5 to 25 microns.
Embodiment 8 is an embodiment of any one of embodiments 1-7, wherein the mixture is prepared by blending, atomization, mechanical alloying, or resonant mixing.
Embodiment 9 is an embodiment of any one of embodiments 1-8, wherein the mixture comprises from 90 to 99.99% by weight of beryllium.
Embodiment 10 is an embodiment of any one of embodiments 1-9, wherein the mixture comprises from 0.01 to 10% by weight of the at least one metal inoculant.
Embodiment 11 is an embodiment of any one of embodiments 1-10, wherein an electron beam or laser is used to apply energy to at least a portion of the layer.
Embodiment 12 is an embodiment of any one of embodiments 1-11, wherein the reducing atmosphere has a volume concentration of 10% by volume or less of oxygen or other oxidizing agents.
Embodiment 13 is an embodiment of any one of embodiments 1-12, wherein the beryllium powder has a D₅₀ average size from 10 to 50 microns.
Embodiment 14 is an embodiment of any one of embodiments 1-13, wherein the at least one metal inoculant has a D₅₀ average size from 0.001 to 5 microns.
Embodiment 15 is an embodiment of any one of embodiments 1-14, wherein the object made by the method comprises beryllium, wherein the beryllium is in a crystalline structure comprising equiaxed grains of beryllium; and at least one metal inoculant selected from the group consisting of Be₂Co, Be₂Nb, Be₂Ta, Be₂Ti, Be₂W, Be₅Hf, Be₅Sc, Be₅Zr, Be₇Cu₁₃, BeFe₃, Cu₃Mo, Cu₉W, Mo, Nb, RbO₂, ReRh, Ta, TiV, and W to form a grains that are 1:1 or 2:1 lattice match to the beryllium grains.
Embodiment 16 is a method of grain refining an object comprising beryllium, the method comprising combining beryllium and at least one metal inoculant selected from the group consisting of Be₂Co, Be₂Nb, Be₂Ta, Be₂Ti, Be₂W, Be₅Hf, Be₅Sc, Be₅Zr, Be₇Cu₁₃, BeFe₃, Cu₃Mo, Cu₉W, Mo, Nb, RbO₂, ReRh, Ta, TiV, and W to form a pre-alloy composition; depositing a layer comprising the pre-alloy composition on a surface; cycling at least a portion of the layer by applying energy to form molten beryllium; solidifying the molten beryllium; and repeating the depositing/cycling/precipitating for successive layers, wherein each of the successive layers comprise the pre-alloy composition and have an average grain size from 1 to 80 microns.
Embodiment 17 is an embodiment of embodiment 16, wherein the pre-alloy composition comprises beryllium powder.
Embodiment 18 is an embodiment of any one of embodiments 16 or 17, wherein the at least one metal inoculant comprises at least one particle selected from the group consisting of Be₂Co, Be₂Nb, Be₂Ta, Be₂Ti, Be₂W, Be₅Hf, Be₅Sc, and Be₅Zr.
Embodiment 19 is an embodiment of any one of embodiments 16-18, wherein the average grain size is from 5 to 40 microns.
Embodiment 20 is an embodiment of any one of embodiments 16-18, wherein the average grain size is from 5 to 25 microns.
Embodiment 21 is an embodiment of any one of embodiments 16-20, wherein the pre-alloy composition is prepared by blending, atomization, mechanical alloying, or resonant mixing.
Embodiment 22 is an embodiment of any one of embodiments 16-21, wherein the pre-alloy composition comprises from 90 to 99.99% by weight of beryllium.
Embodiment 23 is an embodiment of any one of embodiments 16-22, wherein the pre-alloy composition comprises from 0.01 to 10% by weight of the metal inoculant.
Embodiment 24 is an embodiment of any one of embodiments 16-23, wherein an electron beam or laser is used to apply energy to at least a portion of the layer.
Embodiment 25 is an embodiment of any one of embodiments 16-24, wherein the reducing atmosphere has a volume concentration of 10% by volume or less of oxygen or other oxidizing agents.
Embodiment 26 is an embodiment of any one of embodiments 16-25, wherein the beryllium powder have a D₅₀ average size from 10 to 50 microns.
Embodiment 27 is an embodiment of any one of embodiments 16-26, wherein the at least one metal inoculant have a D₅₀ average size from 0.001 to 5 microns.
Embodiment 28 is an object comprising beryllium, wherein the beryllium is in a crystalline structure comprising equiaxed grains of beryllium; and at least one metal inoculant selected from the group consisting of Be₂Co, Be₂Nb, Be₂Ta, Be₂Ti, Be₂W, Be₅Elf, Be₅Sc, Be₅Zr, Be₇Cu₁₃, BeFe₃, Cu₃Mo, Cu₉W, Mo, Nb, RbO₂, ReRh, Ta, TiV, and W to form a grains that are 1:1 or 2:1 lattice match to the beryllium grains; wherein the equiaxed grains of beryllium has an average grain size from 1 to 80 microns.
Embodiment 29 is an embodiment of embodiment 28, wherein the crystalline structure comprises from 50 vol. % to 100 vol. % of equiaxed grains.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit.

We claim:

1. A method of manufacturing an object comprising beryllium, the method comprising:
preparing a mixture of beryllium powder and at least one metal inoculant;
depositing a layer comprising the mixture on a surface;
applying energy to at least a portion of the layer to form molten beryllium in a reducing atmosphere;
solidifying the molten beryllium into a layer comprising a continuous beryllium matrix having a crystalline structure of equiaxed grains; and
repeating the depositing/applying/solidifying for successive layers until the object having a geometric shape is achieved.

2. The method of claim 1, wherein at least a portion of the metal inoculants are bound to the surface of the beryllium powder.

3. The method of claim 1, wherein the at least one metal inoculant comprises at least one particle selected from the group consisting of Be₂Co, Be₂Nb, Be₂Ta, Be₂Ti, Be₂W, Be₅Elf, Be₅Sc, Be₅Zr, Be₇Cu₁₃, BeFe₃, Cu₃Mo, Cu₉W, Mo, Nb, RbO₂, ReRh, Ta, TiV, and W.

4. The method of claim 1, wherein the at least one metal inoculant comprises at least one particle selected from the group consisting of Be₂Co, Be₂Nb, Be₂Ta, Be₂Ti, Be₂W, Be₅Elf, Be₅Sc, and Be₅Zr.

5. The method of claim 1, wherein the continuous beryllium matrix has an average grain size from 1 to 80 microns.

6. The method of claim 1, wherein the continuous beryllium matrix has an average grain size from 5 to 40 microns.

7. The method of claim 1, wherein the continuous beryllium matrix has an average grain size from 5 to 25 microns.

8. The method of claim 1, wherein the mixture is prepared by blending, atomization, mechanical alloying, or resonant mixing.

9. The method of claim 1, wherein the mixture comprises from 90 to 99.99% by weight of beryllium.

10. The method of claim 1, wherein the mixture comprises from 0.01 to 10% by weight of the at least one metal inoculant.

11. The method of claim 1, wherein an electron beam or laser is used to apply energy to at least a portion of the layer.

12. The method of claim 1, wherein the reducing atmosphere has a volume concentration of 10% by volume or less of oxygen or other oxidizing agents.

13. The method of claim 1, wherein the beryllium powder has a D50 average size from 10 to 50 microns.

14. The method of claim 1, wherein the at least one metal inoculant has a D50 average size from 0.001 to 5 microns.

15. A method of grain refining an object comprising beryllium, the method comprising:
combining beryllium and at least one metal inoculant selected from the group consisting of Be₂Co, Be₂Nb, Be₂Ta, Be₂Ti, Be₂W, Be₅Hf, Be₅Sc, Be₅Zr, Be₇Cu₁₃, BeFe₃, Cu₃Mo, Cu₉W, Mo, Nb, RbO₂, ReRh, Ta, TiV, and W to form a pre-alloy composition;
depositing a layer comprising the pre-alloy composition on a surface;
cycling at least a portion of the layer by applying energy to form molten beryllium;
solidifying the molten beryllium; and
repeating the depositing/cycling/precipitating for successive layers, wherein each of the successive layers comprise the pre-alloy composition and have an average grain size from 1 to 80 microns.

16. The method of claim 15, wherein the pre-alloy composition comprises beryllium powder.

17. The method of claim 15, wherein the at least one metal inoculant comprises at least one particle selected from the group consisting of Be₂Co, Be₂Nb, Be₂Ta, Be₂Ti, Be₂W, Be₅Hf, Be₅Sc, and Be₅Zr.

18. The method of claim 15, wherein the pre-alloy composition comprises from 90 to 99.99% by weight of beryllium.

19. The method of claim 15, wherein the pre-alloy composition comprises from 0.01 to 10% by weight of the metal inoculant.

20. An object comprising:
beryllium, wherein the beryllium is in a crystalline structure comprising equiaxed grains of beryllium; and
at least one metal inoculant selected from the group consisting of Be₂Co, Be₂Nb, Be₂Ta, Be₂Ti, Be₂W, Be₅Hf, Be₅Sc, Be₅Zr, Be₇Cu₁₃, BeFe₃, Cu₃Mo, Cu₉W, Mo, Nb, RbO₂, ReRh, Ta, TiV, and W to form a grains that are 1:1 or 2:1 lattice match to the beryllium grains;
wherein the equiaxed grains of beryllium has an average grain size from 1 to 80 microns.
